(19) United States
(12) Patent Application Publication
(10) Pub. No.: US 2026/0128800 A1
(43) Pub. Date: May 7, 2026

(54) LOW POWER MICRO-LED DRIVER FOR HIGH BANDWIDTH SHORT DISTANCE COMMUNICATION

(71) Applicant: Hyperlume Inc., Ottawa (CA)

(72) Inventors: Morteza Nabavi, Ottawa (CA); Hossein Fariborzi, Auburndale, MA (US); Abdolreza Nabavi, Ottawa (CA); Mohsen Asad, Ottawa (CA)

(73) Assignee: Hyperlume Inc., Ottawa (CA)

(21) Appl. No.: 19/054,877

(22) Filed: Feb. 16, 2025

Related U.S. Application Data
(63) Continuation of application No. PCT/CA2024/051455, filed on Nov. 1, 2024.

(51) Int. Cl. H04B 10/564; H04B 10/50; H04B 10/516

(52) U.S. Cl. CPC H04B 10/564; H04B 10/502; H04B 10/5162

(57) ABSTRACT

A driver circuit for supplying and regulating power to a micro light-emitting diode (micro-LED), the driver circuitry comprising: at least one inverter; a first capacitance; a resistor coupled to ground; a fast switch comprising at least one first transistor; and a slow switch comprising at least one second transistor; whereby at least one of a rising time, a peaking effect, and LED power is increased.

### FIELD

Aspects of the disclosure relate to methods and systems for optical communication systems, and more particularly to optical communications over short distances using micro-LEDs.

### BACKGROUND

Lasers tend to dominate optical communications for long distance applications, given their high-speed characteristics and narrow linewidth at the cost of high-power consumption. However, these benefits are not necessarily required for optical communications for very short distances such as chip to chip communications. In addition, due to the high bandwidth required for artificial intelligence (AI application), low power consumptions are needed. As such, chip to chip communications based on micro-LEDs is a suitable candidate for low power communication.

### SUMMARY

In one of its aspects, a driver circuit for supplying and regulating power to a micro light-emitting diode (micro-LED), the driver circuitry comprising:
at least two inverters;
an RC current shaping circuit comprising a first capacitance and a resistor coupled to ground;
a first switch; and
a second switch;
whereby at least one of a rising time, a peaking effect, and the micro-LED's power is increased.

In another aspect, a driver circuit for supplying and regulating power to a micro light-emitting diode (micro-LED), the driver circuit comprising:
at least one first inverter;
a first capacitance;
a first switch;
at least two second inverters, whereby a floating negative voltage is applied between the micro-LED and the first switch.

In another aspect, a driver circuit for supplying and regulating power to a micro light-emitting diode (micro-LED), the driver circuit comprising:
at least one first inverter;
a first switch comprising at least one first transistor;
a shunt transistor to improve a sweep-out effect of a modulated current in the micro-LED's active region when an electrical pulse is turned on and off.

In another aspect, a method comprising the steps of:
generating, using driving circuitry, a drive current to supply to a micro light-emitting diode (micro-LED);
modulating the drive current;
increasing a rising time and a peaking effect of the modulated drive current.

In another aspect, there is provided a driver circuit and equalizer for peaking and sweep out of the signals driving LEDs, such as a micro-LED. In one example, the micro-LED operates at a different supply voltage than the rest of the circuit. The methods and systems described herein address certain limitations associated with micro-LEDs, such as low modulation bandwidth.

### BRIEF DESCRIPTION OF THE DRAWINGS

Several exemplary embodiments of the present disclosure will now be described, by way of example only, with reference to the appended drawings in which:

FIG. 1a shows a driver circuit for supplying and regulating power to a micro light-emitting diode (micro-LED), in one example;

FIG. 1b shows the difference in the modulation signal between a driver circuit of FIG. 1a with assist circuitry and without assist circuitry (simple);

FIG. 2a shows a driver circuit for supplying and regulating power to a micro light-emitting diode (micro-LED), comprising a booster circuit;

FIG. 2b shows an on-off keying (OOK) modulation signal to the micro-LED generated by the driver circuit of FIG. 2a;

FIG. 2c shows the difference in the modulating signal between a driver circuit of FIG. 2a with boosting and without boosting (simple);

FIG. 3a shows a driver circuit for supplying and regulating power to a micro light-emitting diode (micro-LED), comprising additional inverters;

FIG. 3b shows an on-off keying (OOK) modulation signal to the micro-LED generated by the driver circuit of FIG. 3a;

FIG. 4a shows a driver circuit for supplying and regulating power to a micro light-emitting diode (micro-LED), comprising a shunt transistor;

FIG. 4b shows an on-off keying (OOK) modulation signal to the micro-LED generated by the driver circuit of FIG. 4a without the shunt transistor;

FIG. 4c shows the modulation signal without a shunt transistor (simple) and with a shunt transistor;

FIG. 5a shows a driver circuit for supplying and regulating power to a micro light-emitting diode (micro-LED), comprising a booster circuit and additional inverters;

FIG. 5b shows a comparison of the peaking current of a driver circuit of FIG. 5a with a booster circuit and without a booster circuit (simple, no peaking);

FIG. 6a shows a driver circuit for supplying and regulating power to a micro light-emitting diode (micro-LED), comprising a booster circuit and additional inverters, and a shunt transistor;

FIG. 6b shows a comparison of the peaking current with a booster and without a booster circuit (simple, no peaking); and

FIG. 6c shows a comparison of the current in (i) the simple case, (ii) the sweeping out only and (iii) when both boosting and sweeping out are used.

### DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In on example, micro-LEDs, such as GaN based micro-LEDs, are used for low power data links such as integrated circuit chip to chip communications. Generally, micro-LEDs do not have a significant threshold voltage compared to lasers, and can run at a lower drive current compared to lasers, and therefore may be chosen over lasers.

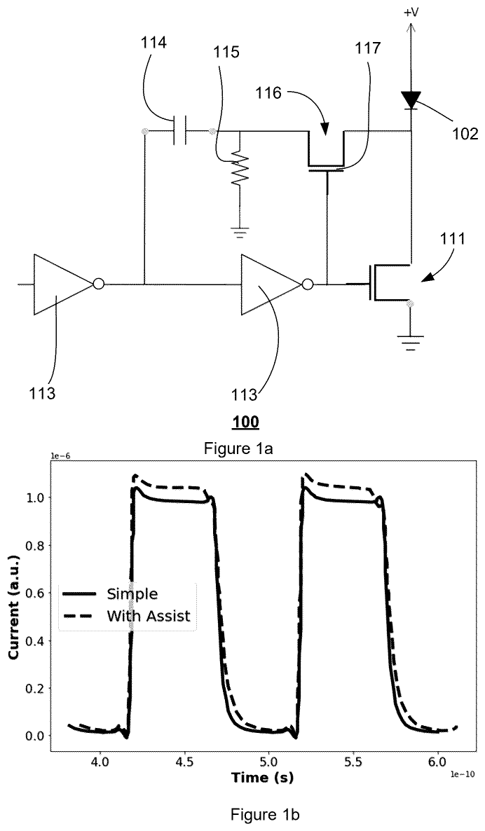

FIG. 1a shows a circuit topology of a driver circuit 100 for a micro-LED 102. The driver circuit 100 comprises a switch 111, such as a transistor, inverters 113, at least one capacitive component 114, such as a capacitor, at least one resistive component 115, such as a resistor, and a switch 116. This driver circuit 100 improves the maximum current. FIG. 1c shows the difference in the modulation signal between a driver circuit 100 with assist circuitry and without assist circuitry (simple).

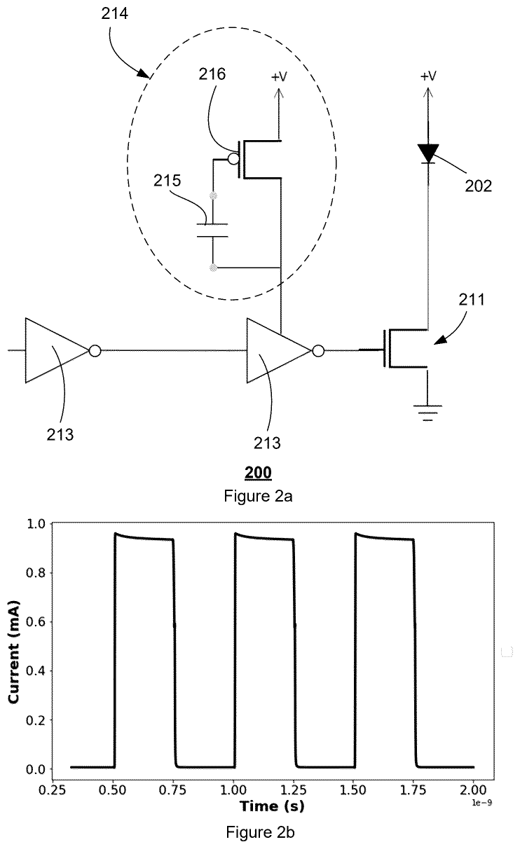

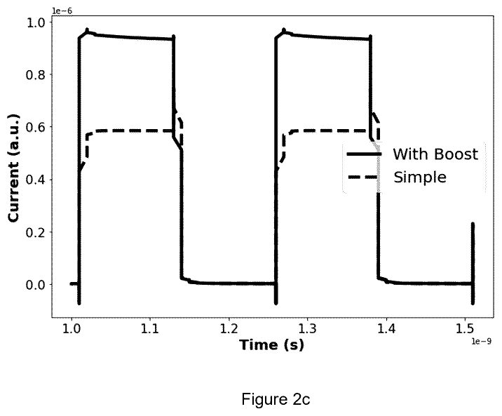

FIG. 2a shows a circuit topology of a driver circuit 200 for a micro-LED 202. The driver circuit 200 comprises a switch 211, inverters 213, and a booster circuit 214 comprising a capacitor 215 and a p-type transistor 216. The booster circuit 213 increases the current by increasing the high voltage of the switch 211. This driver circuit 200 improves the peaking of the current. FIG. 2b shows an on-off keying (OOK) modulation signal to the micro-LED 202 generated by the driver circuit 200 of FIG. 2a. FIG. 2c shows the difference in the modulation signal between a driver circuit 200 with boosting and without boosting (simple).

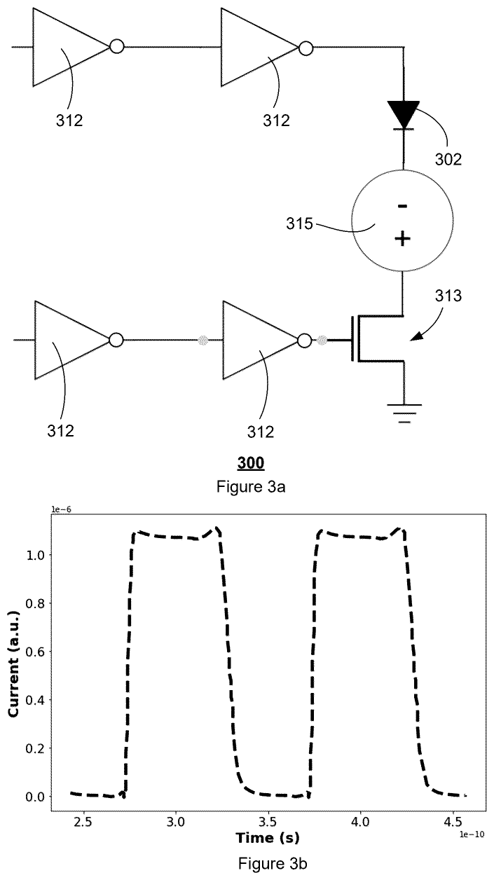

FIG. 3a shows a circuit topology of a driver circuit 300 for a micro-LED 302. The driver circuit 300 comprises inverters 312 and a switch 313, such as a transistor. Since in advanced technologies the switches 313 can tolerate a very low V_{ds} and V_{ds} voltages between the drain and the source of at least one first transistor 313, by adding a negative voltage 315 between the cathode of the micro-LED 302 and the switch 313, V_{gs} and V_{ds} voltage can be kept in the tolerated range. This driver circuit 300 improves the peaking and the sweep out of the current. FIG. 3b shows an on-off keying (OOK) modulation signal to the micro-LED 302 generated by the driver circuit 300 of FIG. 3a. In general cases (previous cases), the negative voltage is set up at the source of the transistor 313. This will significantly increase the V_{gs}. In advanced technologies, this value is very low (such as 0.8V) and if the negative voltage connects at the source of (e.g. ground in FIG. 3a), the transistor 313 becomes inoperative as the V_{gs} goes above the tolerated voltage. The same scenario also occurs for the V_{ds.} As such, the transistor 313 may be kept at the correct and tolerated voltage by keeping a negative voltage between the cathode and the drain of the transistor 313 the. In one example, the negative voltage is about −3.5V, and the LED 302 turns on around this voltage.

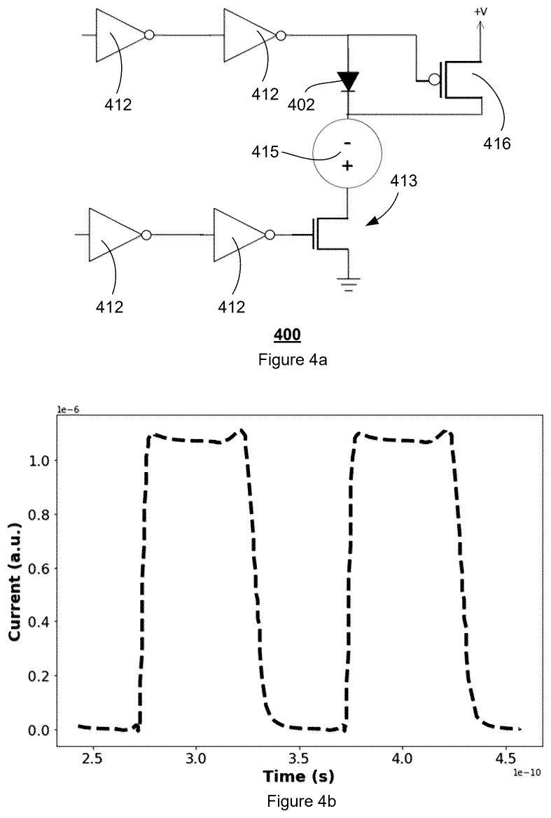

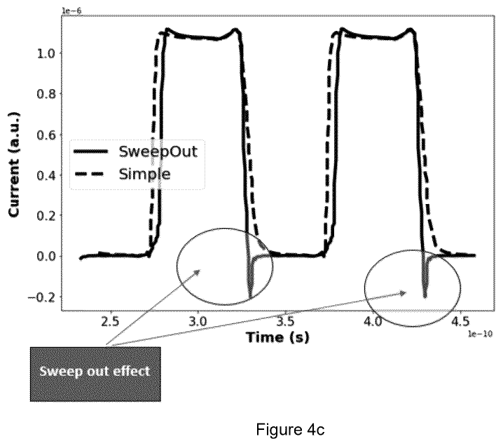

FIG. 4a shows a circuit topology of a driver circuit 400 for a micro-LED 402. The driver circuit 400 comprises inverters 412 and a switch 413, such as a transistor. Since in advanced technologies the switch 413 can tolerate a very low V_{gs} and V_{ds} voltage between the gate/drain and the source of the switch 413, by adding a negative voltage 415 between the cathode of the micro-LED 402 and the switch 413, V_{gs} and V_{ds} voltage can be kept in the tolerated range. The driver circuit 400 comprises an additional shunt p-type transistor 416, which improves the sweeping out effect of the modulated current. FIG. 4b shows an on-off keying (OOK) modulation signal to the micro-LED 402 generated by the driver circuit 400 of FIG. 4 a without a shunt transistor 416. FIG. 4c shows the modulation without a shunt transistor 416 (simple) and with a shunt transistor 416. As can be seen, the sweeping out is significantly pronounced in the case of the shunt transistor 416.

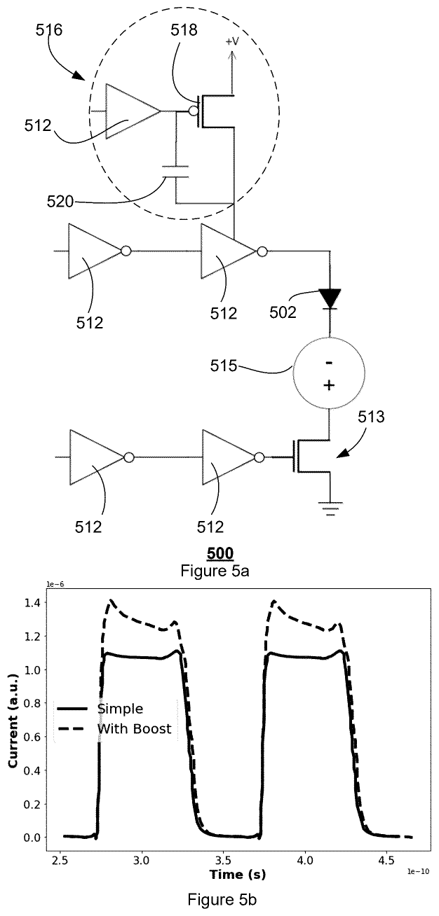

FIG. 5a shows a circuit topology of a driver circuit 500 for a micro-LED 502. The driver circuit 500 comprises inverters 512 and a switch 513, such as a transistor. Since in advanced technologies the switches 513 can tolerate a very low V_{gs} and V_{ds} voltage between the gate/drain and the source of the switch 513, by adding a negative voltage 514 between the cathode of the micro-LED 502 and the switch 513, the V_{gs} and V_{ds} voltage can be kept in the tolerated range. The driver circuit 500 comprises a booster circuit 516 which comprises an inverter 512, a p-type transistor 518 and a capacitor 520. The booster circuit 516 improves the peaking of the modulated current. FIG. 5b shows a comparison of the peaking current of a driver circuit of FIG. 5a with a booster circuit and without a booster circuit 516 (simple, no peaking).

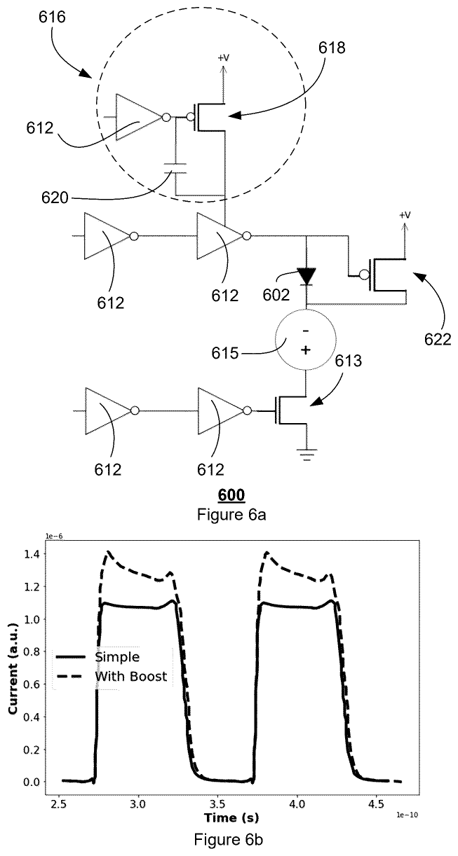

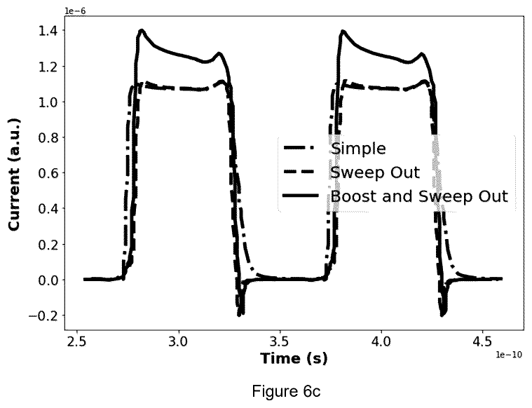

FIG. 6a shows a circuit topology of a driver circuit 600 for a micro-LED 602. The driver circuit 600 comprises inverters 612 and a switch 613, such as a transistor. Since in advanced technologies the switches 613 can tolerate a very low V_{gs} and V_{ds} voltage between the gate/drain and the source of the switch 613, by adding a negative voltage 615 between the cathode of the micro-LED 602 and the switch 613, the V_{gs} and V_{ds} voltage can be kept in the tolerated range. The driver circuit 600 comprises a booster circuit 616 which comprises an inverter 612, a p-type transistor 618 and a capacitor 620. The booster circuit 616 improves the peaking of the modulated current. The driver circuit 600 comprises an additional shunt p-type transistor 622, which improves the sweeping out effect of the modulated current. This structure has both high peaking and significant sweeping out effect. FIG. 6b shows a comparison of the peaking current with a booster 616 and without a booster circuit 616 (simple, no peaking), and FIG. 6c shows a comparison of the current in (i) the simple case, (ii) the sweeping out only and (iii) when both boosting and sweeping out are used. As can be seen, the driver circuit 600 with both the booster circuit 616 and the shunt p-type transistor 622 improves the peaking and the sweep-out frequency.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Accordingly, the above description of example implementations does not define or constrain this disclosure. Other changes, substitutions, and alterations are also possible without departing from the spirit and scope of this disclosure.

1. A driver circuit for supplying and regulating power to a micro light-emitting diode (micro-LED), the driver circuitry comprising:
at least two inverters;
an RC current shaping circuit comprising a first capacitance and a resistor coupled to ground;
a first switch; and
a second switch;
whereby at least one of a rising time, a peaking effect, and the micro-LED's power is increased.

2. A driver circuit for supplying and regulating power to a micro light-emitting diode (micro-LED), the driver circuitry comprising:
at least one inverter;
a first capacitance;
a first switch;
a booster comprising a second capacitance and a second switch to increase a current and a high voltage of the first switch, thereby improving the power of the first switch to increase the rise time and the peaking effect.

3. The driver circuit of claim 2, wherein the second switch comprises a p-type metal-oxide-semiconductor.

4. A driver circuit for supplying and regulating power to a micro light-emitting diode (micro-LED), the driver circuit comprising:
at least one first inverter;
a first capacitance;
a first switch;
at least two second inverters, whereby a floating negative voltage is applied between the micro-LED and the first switch.

5. The driver circuit of claim 4, further comprising a booster circuit comprising at least one transistor and a second capacitance, wherein the booster circuit improves a peaking of a modulated current to the micro-LED.

6. The driver circuit of claim 5, wherein the at least one transistor comprises a p-type metal-oxide-semiconductor.

7. The driver circuit of claim 6, further comprising:
a shunt transistor to improve a sweep-out effect of a modulated current in the micro-LED's active region when an electrical pulse is turned on and off; and
wherein the booster circuit comprises an inverter.

8. The driver circuit of claim 5, wherein the shunt transistor improves the micro-LED's modulation rate.

9. The driver circuit of claim 1, wherein a negative voltage is applied between a cathode of the micro-LED and the first switch, and wherein a Vgₛ and V_{ds} voltage between a gate/drain and a source of the at least one first transistor is maintained within a predetermined range.

10. A driver circuit for supplying and regulating power to a micro light-emitting diode (micro-LED), the driver circuit comprising:
at least one first inverter;
a first switch comprising at least one first transistor;
a shunt transistor to improve a sweep-out effect of a modulated current in the micro-LED's active region when an electrical pulse is turned on and off.

11. The driver circuit of claim 10, wherein the shunt transistor improves the micro-LED's sweeping out.

12. The driver circuit of claim 10 or claim 11, wherein a negative voltage is applied between a cathode of the micro-LED and the first switch, and wherein a V_{gs} and V_{ds} voltage between a gate/drain and a source of the first switch is maintained within a predetermined range.

13. A method comprising the steps of:
generating, using driving circuitry, a drive current to supply to a micro light-emitting diode (micro-LED);
modulating the drive current;
increasing a rising time and a peaking effect of the modulated drive current.

14. The method of claim 13, further comprising improve a sweep-out effect of a modulated current in the micro-LED's active region when an electrical pulse is turned on and off.

15. The method of claim 13, further comprising a step of applying a negative voltage is between a cathode of the micro-LED and a switch comprising at least one first transistor.

16. The method of claim 15, further comprising a step of maintaining a V_{gs} and V_{ds} voltage between a gate/drain and a source of the at least one first transistor within a predetermined range.

17. The method of claim 15, further comprising a step of, with a plurality of inverters, to improve the rising time and the peaking effect.

18. The method of claim 13, further comprising a step of, with a shunt transistor, improving the micro-LED's modulation rate and improving a sweep-out effect of a modulated current in the micro-LED's active region when an electrical pulse is turned on and off.

19. The method of claim 13, further comprising a step of, with a booster circuit comprising at least one transistor and a second capacitance, improves a peaking of a modulated current to the micro-LED.

20. The method of claim 13, further wherein the at least one first transistor comprises a p-type metal-oxide-semiconductor.
